(19) United States
(12) Patent Application Publication
(10) Pub. No.: US 2025/0381826 A1
(43) Pub. Date: Dec. 18, 2025

(54) Device for a vehicle roof, and vehicle roof for a motor vehicle

(71) Applicant: Webasto SE, Stockdorf (DE)

(72) Inventors: Andrei POPOVICI, Stockdorf (DE); Christian BECKER, Stockdorf (DE)

(21) Appl. No.: 19/228,309

(22) Filed: Jun. 4, 2025

(30) Foreign Application Priority Data
Jun. 12, 2024 (EP) 24181669.3

(51) Int. Cl. B60J 7/043; B60J 7/057

(52) U.S. Cl. CPC B60J 7/0435; B60J 7/0573

(57) ABSTRACT

A device for a vehicle roof has a cover, a lever mechanism and a guide rail made of plastics material. The lever mechanism is coupled to the cover and is designed to move the cover relative to the vehicle roof. The lever mechanism has a driving slide and a plurality of levers having guide elements which are coupled to a plurality of guide tracks and slotted guide tracks of the guide rail in such a way that the cover by the lever mechanism and the guide rail is able to be transferred from a closed position to a ventilation position and, from the ventilation position along a longitudinal axis of the vehicle roof, to an open position.

### CROSS-REFERENCE TO RELATED APPLICATION(S)

This application claims the benefit of EP Application Serial No. 24181669.3, filed Jun. 12, 2024, which is incorporated herein by reference in its entirety.

### TECHNICAL FIELD

The invention relates to a device for a vehicle roof. The invention furthermore relates to a vehicle roof having such a device.

### BACKGROUND

Some motor vehicles have vehicle roofs with one or a plurality of covers, which permit a view through the vehicle roof and are designed as movable components and enable an opening in the vehicle roof to be selectively exposed and closed. It is always a challenge herein to keep costs low and to enable a space-saving construction.

### SUMMARY

It is an object on which the invention is based to achieve a device for a vehicle roof having a cover, which enables a simple and cost-effective construction of a vehicle roof, and a space-saving construction, and reduces the CO2 emissions in comparison to solutions to date. It is furthermore an object to achieve a vehicle roof having such a device.

The respective object is achieved by the features of the respective independent patent claims. Advantageous refinements are set forth in the dependent patent claims.

A device according to the invention for a vehicle roof for a motor vehicle comprises a cover which is designed to establish a displaceable roof element for the vehicle roof, which is able to be deployed and retracted so as to expose or close an opening in the vehicle roof when required. The cover can be specified so as to be able to be coupled to a roof bodywork of the vehicle roof by means of a cover support and/or a cover plate. The device furthermore comprises a lever mechanism and a guide rail made of plastics material, which are coupled to one another and to the cover. The lever mechanism is designed to move the cover relative to the vehicle roof, and comprises a driving slide and a plurality of levers and guide elements. The guide rail made of plastics material has a plurality of guide tracks and slotted guide tracks which are formed so as to be adapted to the driving slide and the guide elements of the lever mechanism and interact with these. In this way, the cover, by means of the lever mechanism and the guide rail, is able to be transferred from a closed position to a ventilation position and, from the ventilation position along a longitudinal axis of the vehicle roof, to an open position. A correspondingly reversed motion sequence for retrieving and retracting the cover can likewise be carried out by means of the device.

A construction of the vehicle roof is able to be implemented in a simple and cost-effective way which moreover enables a space-saving design by means of the device described. The device can be operated by means of only one electrical drive unit and by virtue of the embodiment of the guide rail using a plastics material enables a multiplicity of shapes. In comparison to conventional metal guide rails, a contribution to an improved CO2 footprint and a reduced generation of noise when moving displaceable components in or on the guide rail can furthermore be made by means of the plastic guide rail.

According to a refinement of the device, the guide rail is formed integrally with a plurality of guide tracks and slotted guide tracks by means of plastics injection-moulding. A particularly positive CO2 footprint can be achieved by using environmentally friendly plastics materials, for example recycled plastics material, and the guide rail can moreover be designed with a multiplicity of variously shaped openings, tracks, recesses and/or channels in a relatively simple and cost-effective manner.

According to a further refinement of the device, the guide rail in terms of a cross section perpendicular to the longitudinal axis is designed to be T-shaped, and has on opposite sides on the right and the left along the longitudinal axis in each case one guide channel for the driving slide.

In the context of this description, terms such as “top”, “bottom”, “front”, “rear”, “right”, “left”, “horizontal” and “vertical” relate to an operationally ready orientation of an associated motor vehicle which comprises a vehicle roof having a design embodiment of the device. Accordingly, the longitudinal axis of the vehicle roof extends between a front and a rear of the motor vehicle and may also represent a usual forward travelling direction.

According to a further refinement of the device, the driving slide comprises a first lateral arm having a coupling element and a second lateral arm having a coupling element, which in terms of the longitudinal axis are formed on opposite sides of the driving slide, on the right and the left. The lateral arms are formed so as to be adapted to guide channels of the guide rail in such a way that the coupling elements engage in the respectively assigned guide channel, and the driving slide in terms of a cross section perpendicular to the longitudinal axis has a U-shape or bracket-shape. The driving slide thus covers in portions an upper side or a lower side of the guide rail as well as a right and a left side of the guide rail. In particular, the driving slide can be driven by means of an electric motor and a driving cable, wherein the guide rail accordingly has an associated guide channel for the driving cable.

The coupling elements of the driving slide and potentially further elements movably mounted in guide channels, slotted guide tracks and/or openings, and/or also the guiding contours of the guide rail are preferably formed or coated to promote slippage in such a way that low-resistance and reliable guiding of these elements is provided.

According to a further refinement of the device, the driving slide has a longitudinal arm which extends largely along the longitudinal axis and has a driver which is designed so as to be adapted to a slotted guide track of a first tilting lever of the lever mechanism in such a way that the driver is guidable within the slotted guide track.

The first tilting lever of the lever mechanism can also be referred to as the front tilting lever, and in one embodiment comprises a first lateral arm having two coupling elements and a second lateral arm having the slotted guide track and the coupling element. The lateral arms in terms of the longitudinal axis are formed on opposite sides of the front tilting lever. In an operationally ready state of the device, the coupling elements of the first lateral arm are mounted so as to be guidable within a slotted guide track of the guide rail, and the coupling element of the second lateral arm is mounted so as to be guidable within a guide channel of the guide rail in such a way that the first tilting lever in terms of a cross section perpendicular to the longitudinal axis has a U-shape or bracket shape and surrounds three sides of the guide rail.

According to a further refinement of the device, the driver by means of the driving slide is displaceable within the slotted guide track, and interacts with a detent of the slotted guide track of the first tilting lever in such a way that, during the continued displacement of the driving slide, the first tilting lever is raised and, as a result, a cover front edge is lifted and subsequently, during the continuing displacement of the driving slide, entrains the raised first tilting lever and the lifted cover towards the rear.

According to a further refinement of the device, the guide rail has a locking slotted guide track, and the lever mechanism has a locking lever having a locking protrusion. The locking lever is on one side coupled to the driving slide and on the other side coupled to the guide rail in such a way that the locking protrusion within the locking slotted guide track is able to be transferred between an unlocked and a locked state by means of the driving slide.

The locking lever is in particular coupled in a sliding manner to the driving slide, and on the other side is pivotally coupled to a second tilting lever of the lever mechanism, and is mounted so as to be guidable within one or a plurality of slotted guide tracks of the guide rail in such a way that, by means of the driving slide, the locking lever is able to be driven and the second tilting lever is able to be raised and, as a result, a cover rear edge is able to be lifted, and the locking lever by means of the locking protrusion within the locking slotted guide track secures the raised second tilting lever. The slotted guide tracks can be directed downwards, in particular at the rear end. The second tilting lever can also be referred to as the rear tilting lever. When forming the ventilation position of the cover, the rear tilting lever is raised before the front tilting lever in temporal terms, so that an air gap between the cover and the roof skin or at the roof bodywork is exposed at the lifted rear cover edge. Subsequently, the front tilting lever is then raised, and the lifted cover can be displaced rearwards over the vehicle roof.

According to a further refinement of the device, the second tilting lever by means of a slider is coupled in a sliding manner to the cover in such a way that, during the continuing displacement of the driving slide, the cover is displaceable in a sliding manner relative to the raised and secured second tilting lever. In this way, the slider forms a support surface or a support structure for the raised cover, over which the latter can slide out up to a predefined projection.

The described embodiments of the device enable in each case a simple, space-saving and cost-effective construction of a vehicle roof. In the context of the present invention it is a known concept that conventional mechanisms and guide systems often require two or more drive units, and have a relatively poor CO2 footprint. Moreover, aluminium or metal guide rails are often designed to be substantially U-shaped for production reasons, and not suitable for a change in terms of material, and moreover require more installation space, in particular in the horizontal plane.

By means of the described construction of the device, and in particular due to the plastic guide rail and the locking lever, the cover can only be displaced reliably and safely using only one electric drive. Furthermore, the required installation space in the horizontal plane, in particular in the transverse direction transverse to the longitudinal axis, can be reduced, and the CO2 footprint can moreover be improved by using alternative, environmentally friendly materials for the guide rail. Moreover, a robust locking function can be established by means of the locking lever, which is preferably also made of plastics material, and the guide rail, said robust locking function moreover contributing to less noise being generated when switching or displacing the levers. Furthermore, the locking lever, the front tilting lever, the rear tilting lever and/or the thrust bar and/or high-load components can be made partially or completely of plastics material, and can furthermore contribute to an improved CO2 footprint owing to the use of alternative, environmentally friendly materials.

A vehicle roof according to the invention for a motor vehicle comprises a roof bodywork which surrounds an opening in the vehicle roof, and an embodiment of the above-described device. The device is coupled to the roof bodywork in such a way that the cover closes the opening in the vehicle roof, or can expose the latter by means of the lever mechanism when required.

Owing to the fact that the vehicle roof comprises an embodiment of the device, features and characteristics of the above-described device are also disclosed with a view to the vehicle roof and vice versa. Moreover, it is pointed out that usually one embodiment of the above-described device is in each case installed on opposite sides of the vehicle roof in terms of the longitudinal axis, so that the respective components are disposed and/or designed to be mirror-symmetrical in terms of a centric symmetry axis. The cover is understandably present once, and comprises, for example, a glass pane or a laminated glass with a foam bonding.

### BRIEF DESCRIPTION OF DRAWINGS

Exemplary embodiments of the invention are explained in more detail hereunder by means of the schematic drawings in which:

FIG. 1 shows a vehicle roof for a motor vehicle, in a perspective view;

FIGS. 2-7 show an exemplary embodiment of a device for a vehicle roof in various states and respective lateral views; and

FIGS. 8-14 show exemplary embodiments of components of the device for the vehicle roof, in perspective views.

### DETAILED DESCRIPTION

Elements of identical construction of function are provided with the same reference signs in all figures. For reasons of clarity, not all elements illustrated may be provided with associated reference signs in all of the figures.

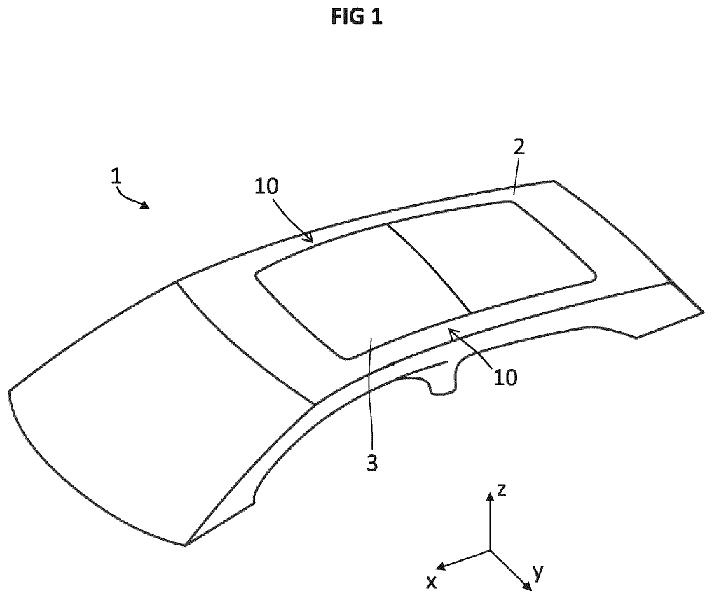

FIG. 1 schematically shows, in a perspective view, a vehicle roof 1 for a motor vehicle. The vehicle roof 1 comprises a device 10 having a cover 3 which by means of a cover support 17 is coupled to a roof bodywork 2 of the motor vehicle. The vehicle roof 1 can furthermore comprise an additional cover so that the cover 3 in terms of a longitudinal axis L of the vehicle roof 1 establishes a front cover, for example. The longitudinal axis L also represents a longitudinal axis of the motor vehicle, and for improved orientation according to the illustrated direction of the arrow moreover represents a usual direction of travel of the operationally ready motor vehicle towards the front.

Terms such as “top”, “bottom”, “front”, “rear”, right”, “left”, horizontal” and “vertical” relate to an orientation of the respective components according to an operationally ready design embodiment of the vehicle roof 1 on a motor vehicle, as is indicated in FIG. 1. In the description hereunder, one side of the vehicle roof 1 and one device 10 will be discussed. However, a correspondingly analogous design is to be provided on the other side of the vehicle roof 1, so that components of the device 10 are disposed and/or designed to be mirror-symmetrical in terms of the longitudinal axis L.

By means of the device 10, the cover 3 is specified to form a tiltable roof element which can furthermore be displaced over the vehicle roof 1 towards the rear. In this way, an opening in the vehicle roof 1 can be exposed or closed when required. For this purpose, the device 10 has a lever mechanism and a guide rail 11 which is made of plastics material, said lever mechanism and said guide rail 11 being coupled to one another.

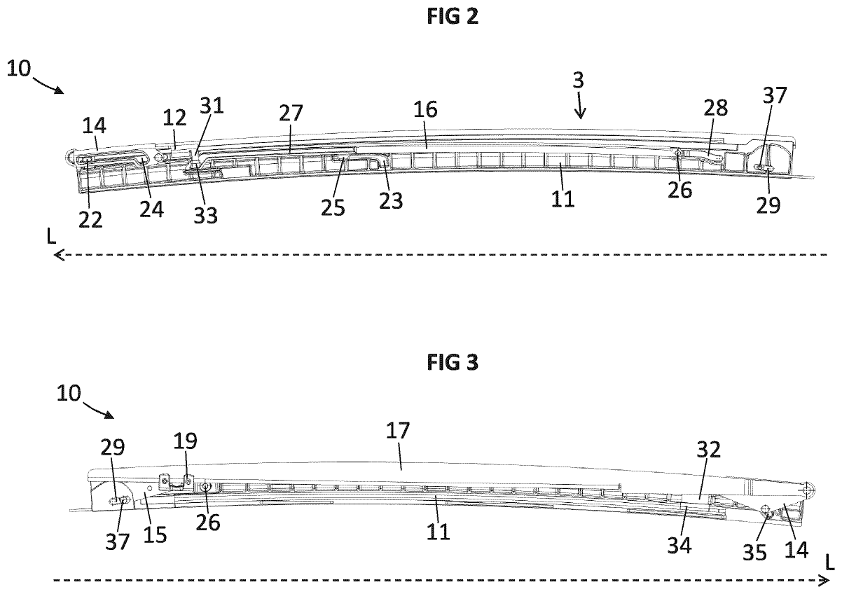

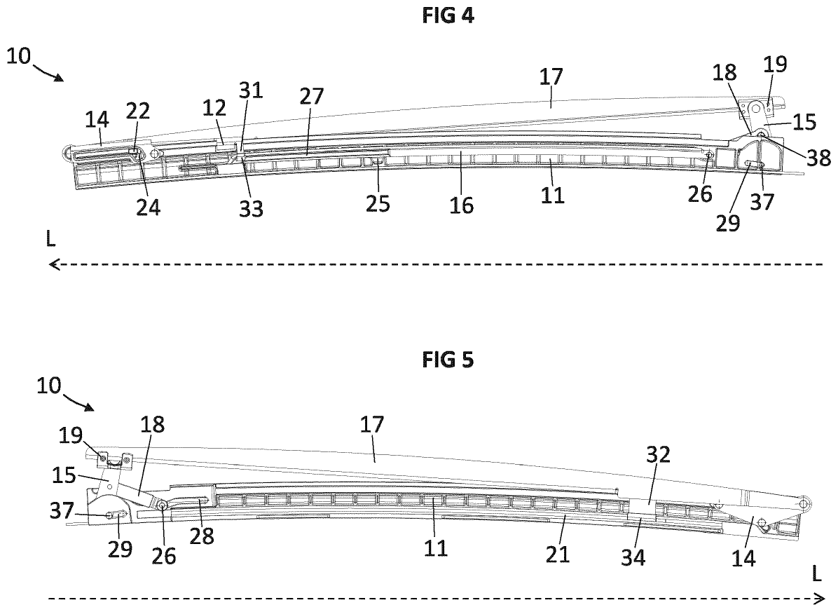

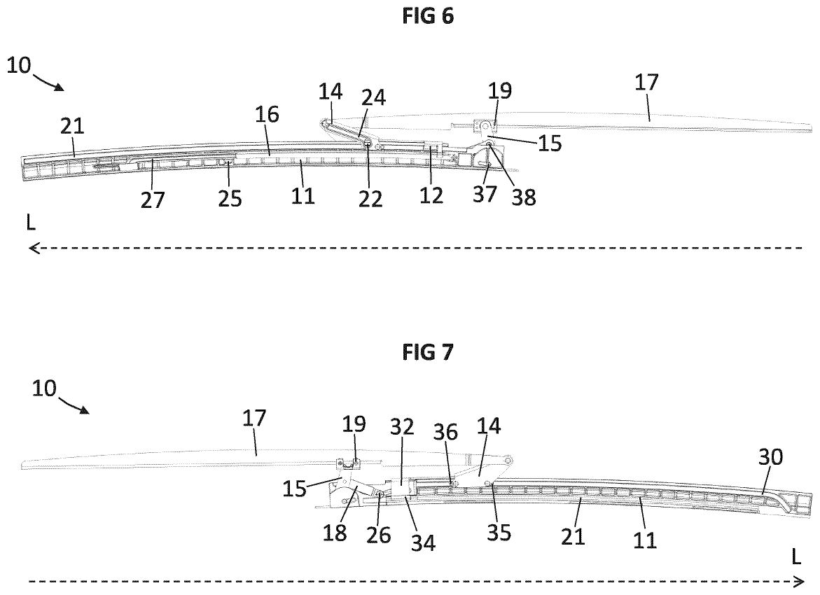

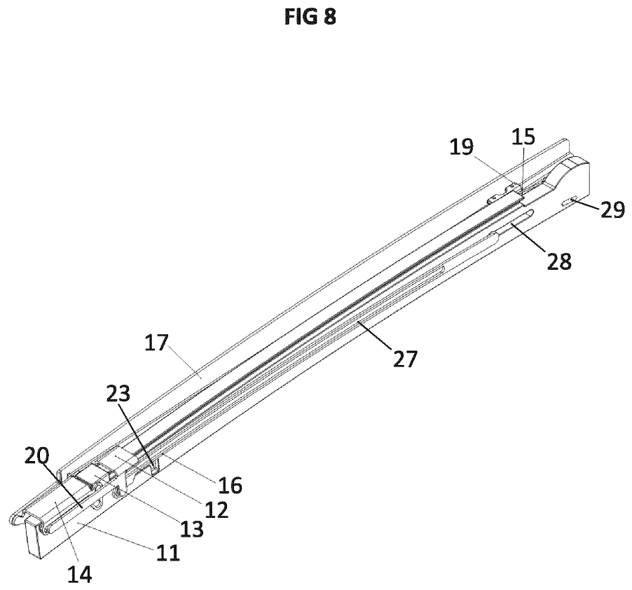

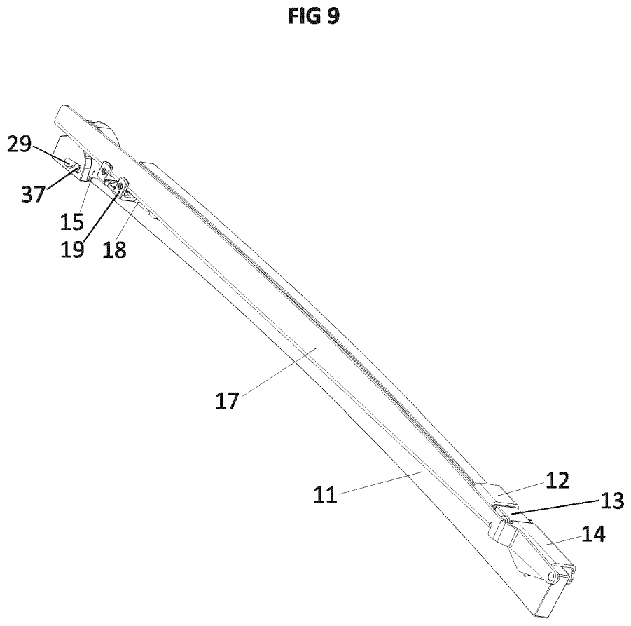

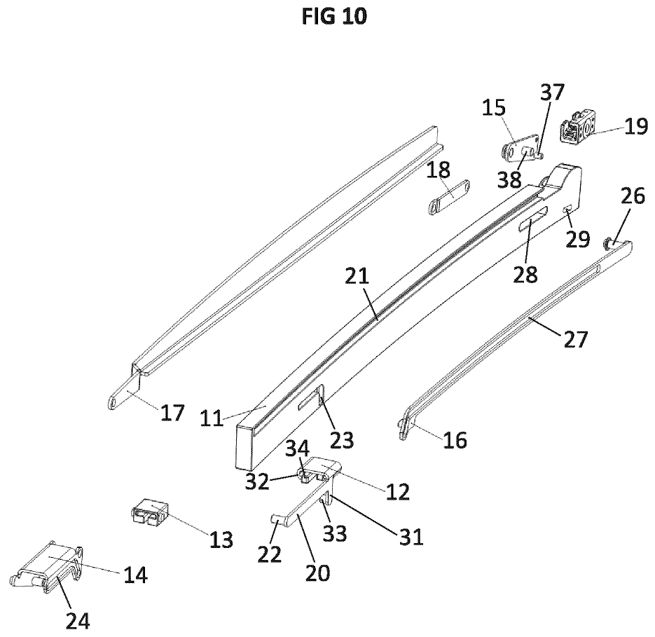

As will be explained by means of FIGS. 2 to 10 hereunder, the device 10 enables a simple and cost-effective construction of the vehicle roof 1, and moreover allows a space-saving design. FIGS. 2 to 7 show the device 10 in different states in respective side views. FIGS. 2 and 3 show the device 10 in a state, in which the cover 3 is closed. FIGS. 4 and 5 show the device 10 in a state in which the cover 3 is lifted at a rear edge and assumes a ventilation position. FIGS. 6 and 7 show the device 10 in a state in which the cover 3 is also lifted at a front edge and is displaced towards the rear over the vehicle roof 1 in such a way that an open position is established. FIGS. 8 and 10 show an exemplary embodiment of components of the device 10 in perspective views.

The lever mechanism of the device 10 is coupled to the cover 3, or the cover support 17, and is designed to move the cover 3 relative to the vehicle roof 1. The lever mechanism comprises a driving slide 12, a guiding slide 13, a first, front tilting lever 14, a second, rear tilting lever 15, a locking lever 16, a thrust lever 18 and a slider 19. The respective components of the lever mechanism interact with one another and/or have guide elements which are designed so as to be adapted to corresponding guide receptacles of the guide rail 11.

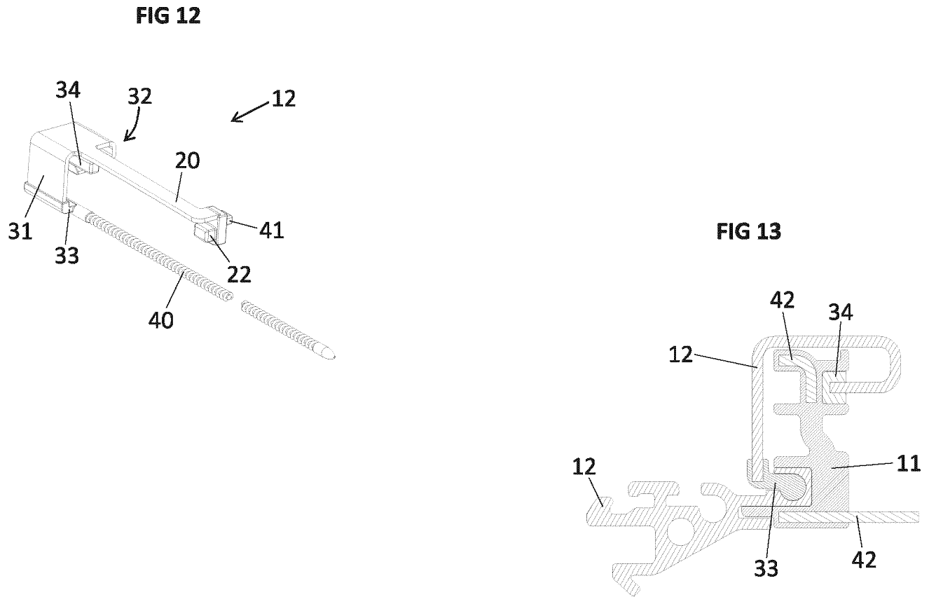

The guide rail 11 in terms of a cross section transverse to the longitudinal axis L is designed to be T-shaped and is integrally formed from plastics material. The guide rail 11 has a plurality of guide channels 21 and slotted guide tracks 23, 28, 29, 30. The guide channels 21 are formed on opposite sides of the guide rails 11 and adapted to coupling elements which are disposed on respective lateral arms 31, 32 of the driving slide 12 and are mounted so as to be guidable in the assigned guide channel 21. Furthermore, coupling elements of the passive guiding slide 13 engage in the guide channel 21 (cf. also FIG. 10). The guiding slide 13 can alternatively also have two separate sliders is which are coupled to the front tilting lever 14 and contribute to directed guiding of the components of the device 10. By means of a coupling element 33 on the first lateral arm 31, the driving slide 12 can moreover engage in a slotted guide track 27 of the locking lever 16 and/or be coupled to a driving cable 40 (cf. FIGS. 12 to 14).

The slotted guide tracks 23, 28, 29 and 30 are designed so as to correspond to coupling elements of the locking lever 16, of the front tilting lever 14 and of the rear tilting lever 15. The locking lever 16 has a locking protrusion 25 which is mounted so as to be guidable within the slotted guide track 23 of the guide rail 11, and in a locking position plunges downwards into a pocket of the slotted guide track 23 (cf. FIGS. 2, 4 and 6). Furthermore, the locking lever 16 has a coupling element 26 which is mounted so as to be guidable in the slotted guide track 28 and penetrates the latter, and on the opposite side is coupled to the thrust lever 18.

The front tilting lever 14 has coupling elements 35, 36 which are mounted so as to promote slippage in the slotted guide track 30 of the guide rail 11 (cf. FIG. 7). On the opposite side, a coupling element of the front tilting lever 14 engages in the guide channel 21 of the guide rail 11. The front tilting lever 14 has on this side a slotted guide track 24 in which a driver 22 of the driving slide 12 engages, said driver being formed on a longitudinal arm 20 of the driving slide 12 that extends towards the front, in the direction of the front tilting lever 14 (cf. FIG. 10). Additionally, a coupling element 41 can also be provided on the longitudinal arm 22, which is disposed opposite the driver 22, for example, and establishes a guide element which contributes to controlled guiding of the driving slide 12 (cf. FIG. 12).

The rear tilting lever 15 has two coupling elements 37, 38 which engage in slotted guide tracks of the guide rails 11 and are mounted so as to be guidable therein. The coupling element 37 is disposed within the slotted guide track 29, and the coupling element 38 is disposed in an upwardly open slotted guide track 39 of the guide rail 11 in such a way that the coupling element 38 when raising or tilting the rear cover edge can exit the slotted guide track towards the top (cf. FIGS. 4, 6 and 11) in a defined manner.

The front tilting lever 14 is pivotably coupled to the cover support 17, the guide rail 11 and the driving slide 12. The front tilting lever 14 and the driving slide 12, by virtue of their lateral arms and coupling elements, are designed to be U-shaped for bracket-shaped to some extent, and cover in portions three sides of the guide rails 11. The driving slide 12 is coupled to the guide rail 11 so as to be displaceable along the latter. The driving slide 12 is coupled to the front tilting lever 14 by means of the driver 22. The driving slide 12 is coupled in a sliding manner to the locking lever 16 by means of the coupling element 33. Alternatively or additionally, the coupling element 33 can be formed as part of a plastic overmoulding on the driving cable 40 and be coupled to the driving slide 12.

The locking lever 16 is coupled in a sliding manner to the driving slide 12, and is furthermore coupled to the guide rails 11. Furthermore, the locking lever 16 is pivotably coupled to the thrust lever 18 by means of the coupling element 26. The thrust lever 18 in turn is pivotably coupled to the rear tilting lever 15. The rear tilting lever 15 in turn is pivotably coupled to the guide rail 11, and by means of the slider 19 pivotably coupled to the cover support 17. The slider 19 provides a slippage-promoting support surface or support structure for the cover 3, over which said slider slides rearwards when the open position is established.

By means of the lever mechanism and the plastic guide rail 11, the cover 3 can be transferred reliably from the closed position (cf. FIGS. 2 and 3) to the ventilation position (cf. FIGS. 4 and 5), and from the ventilation position along the longitudinal axis, to the open position (cf. FIGS. 6 and 7).

Proceeding from the closed position according to FIGS. 2 and 3, the driving slide 12 is driven by means of an electric drive unit which comprises, for example, an electric motor and a driving cable. The driving slide 12 slides rearwards along the guide rail 11, and accordingly also the driver 22 within the slotted guide track 24. Moreover, the driving slide 12 by means of the coupling element 33 of the first lateral arm 31, which is disposed within the slotted guide track 27, also entrains the locking lever 16 towards the rear. The locking lever 16 in turn drives the thrust lever 18 which raises the rear tilting lever 15 and lifts the rear cover edge (cf. FIGS. 4 and 5). The first coupling element 37 of the rear tilting lever 15 in the process reaches the rear end of the slotted guide track 29. Moreover, the second coupling element 38 exits the open slotted guide track of the guide rail 11 towards the top in a defined manner. In this way, the rear tilting lever 15 is tilted, and the ventilation position is initiated.

When the coupling element 26 of the locking lever 16 reaches the rear end of the slotted guide track 28, the locking lever 16 can no longer be displaced further relative to the guide rail 11, and remains stationary from this point on. When the driving slide 12 now continues to be displaced toward the rear, the first lateral arm 31, with the coupling element 33, continues to slide towards the rear in the slotted guide track 27, now moving relative to the locking lever 16. According to the defined guiding by the slotted guide track 27, the locking lever 16 is pushed downwards by the driving slide 12 in such a way that the locking protrusion 25 plunges into the lower end of the slotted guide track 23. The locking lever 16 is thus fixed and secures, or locks, the raised rear tilting lever 15. The ventilation position of the cover 3 is thus secured or locked.

Moreover, in this state the driver 22 reaches the rear end of the slotted guide track 24 of the first tilting lever 14, plunges downwards along the defined track and entrains the front tilting lever 14. During the continuing displacement of the driving slide 12, and due to the defined guiding of the slotted guide track 30 of the guide rail 11, the front tilting lever 14 is raised by the driver 22 and the coupling elements 35, 36 in such a way that the front cover edge is now also lifted. During the continuing displacement, the tilted front tilting lever 14 is entrained along the guide rail 11 towards the rear by means of the driver 22, and the cover 3 slides over of the slider 19 of the tilted and secured rear tilting lever 15 until the complete open position is optionally achieved. A correspondingly reversed motion sequence enables adjusting of the open position to the ventilation position and onward to the closed position of the cover 3.

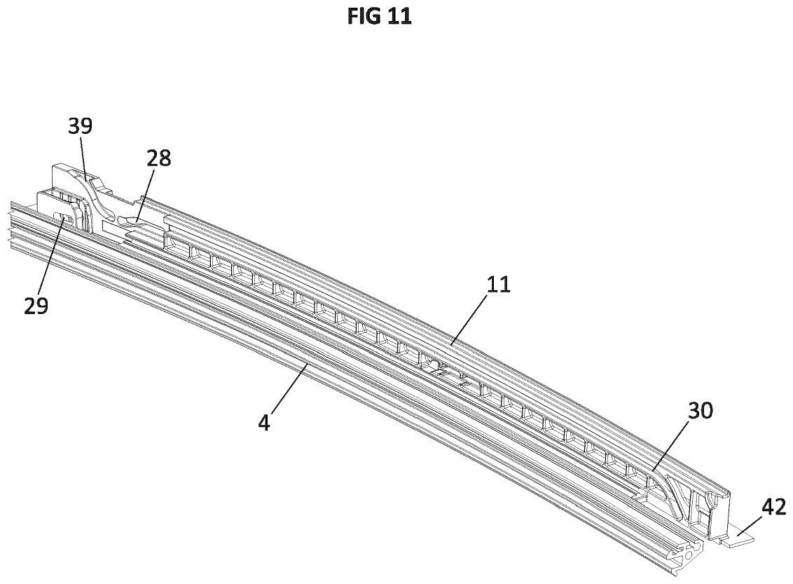

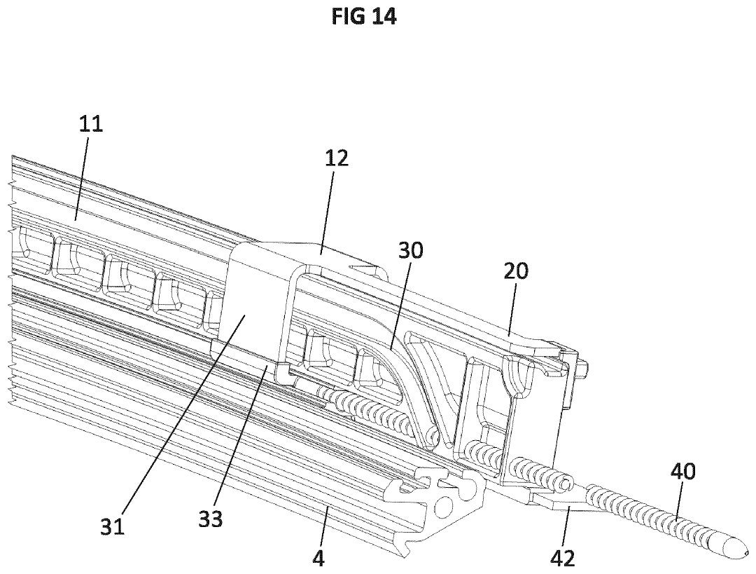

FIGS. 11 to 14 show further views and exemplary embodiments of components of the device 10 in various views. The guide rail 11 can be coupled to the roof bodywork 2 by means of an attachment rail 4. The driving slide 12 can have a coupling element 34 on one or both lateral arms 31, 32, said coupling element engaging in a predefined guide channel of the guide rail 11 and contributing to stable and reliable guiding of the components of the device 10 (cf. FIGS. 10 and 12). Furthermore, the guide rail 11 can comprise one or a plurality of reinforcement elements 42 which are attached thereto, or in the embodiment thereof in plastics material are partially or completely embedded therein (cf. FIGS. 11, 13 and 14). The guide rail 11 can in particular have passage openings or channels for the driving cable 40 (cf. FIG. 14).

A construction of the vehicle roof 1, which enables a space-saving design in particular with a view to a lateral extent in the y-direction, is able to be implemented in a simple and cost-effective way by means of the device 10 described. The device 10 can be operated by means of only one electric drive unit, and due to the embodiment of the guide rail 11 in plastics material enables a multiplicity of shapes. In comparison to conventional metal guide rails, a contribution can furthermore be made to an improved CO2 footprint and a reduced generation of noise when moving or displacing components in or on the guide rail 11 by means of the plastic guide rail

### LIST OF REFERENCE SIGNS

1 Vehicle roof
2 Roof bodywork
3 Cover
4 Attachment rail
10 Device
11 Guide rail
12 Driving slide
13 Guiding slide
14 First, front tilting lever
15 Second, rear tilting lever
16 Locking lever
17 Cover support
18 Thrust lever
19 Slider of the rear tilting lever
20 Longitudinal arm of the driving slide
21 Guide channel of the guide rail
22 Driver of the driving slide
23 Locking slotted guide track
24 Slotted guide track of the front tilting lever
25 Locking protrusion
26 Coupling element of the locking lever
27 Slotted guide track of the locking lever
28 Slotted guide track of the guide rail
29 Slotted guide track of the guide rail
30 Slotted guide track of the guide rail
31 First lateral arm of the driving slide
32 Second lateral arm of the driving slide
33 Coupling element
34 Coupling element of a lateral arm
35 First coupling element of the front tilting lever
36 Second coupling element of the front tilting lever
37 First coupling element of the rear tilting lever
38 Second coupling element of the rear tilting lever
39 Slotted guide track of the guide rail
40 Driving cable
41 Coupling element
42 Reinforcement element of the guide rail
L Vehicle longitudinal axis

1. A device for a vehicle roof 1, having:
a cover, which is designed to be coupled to a roof bodywork of the vehicle roof and to establish a displaceable roof element in the vehicle roof, so as to expose or close an opening in the vehicle roof when required;
a lever mechanism which is coupled to the cover and is designed to move the cover relative to the vehicle roof, wherein the lever mechanism comprises a driving slide and a plurality of levers having guide elements; and
a guide rail made of plastics material, having a plurality of guide tracks and slotted guide tracks which are designed so as to be adapted to the driving slide and the guide elements of the lever mechanism and are coupled to the driving slide and the guide elements in such a way that the cover by the lever mechanism and the guide rail is able to be transferred from a closed position to a ventilation position and, from the ventilation position along a longitudinal axis of the vehicle roof, to an open position.

2. The device according to claim 1, wherein the guide rail is formed integrally with the plurality of guide tracks and slotted guide tracks by plastics injection-moulding.

3. The device according to claim 1, wherein the guide rail in terms of a cross section perpendicular to the longitudinal axis is designed to be T-shaped, and has on opposite sides along the longitudinal axis in each case one guide channel for the driving slide.

4. The device according to claim 1, wherein the driving slide has a first lateral arm having a coupling element and a second lateral arm having a coupling element, which in terms of the longitudinal axis are formed on opposite sides of the driving slide and so as to be adapted to the guide channels of the guide rail in such a way that the driving slide in terms of a cross section perpendicular to the longitudinal axis has a U-shape or bracket-shape and surrounds three sides of the guide rail.

5. The device according to claim 1, wherein the driving slide has a longitudinal arm which extends largely along the longitudinal axis and has a driver which is designed so as to be adapted to a slotted guide track of a first tilting lever of the lever mechanism in such a way that the driver is guidable within the slotted guide track.

6. The device according to claim 1,
wherein the first tilting lever of the lever mechanism has a first lateral arm having two coupling elements and a second lateral arm having the slotted guide track and a coupling element, which in terms of the longitudinal axis are formed on opposite sides of the first tilting lever,
wherein the coupling elements of the first lateral arm are mounted so as to be guidable within a slotted guide track of the guide rail, and
wherein the coupling element of the second lateral arm is mounted so as to be guidable within a guide channel of the guide rail in such a way that the first tilting lever in terms of a cross section perpendicular to the longitudinal axis has a U-shape or bracket-shape and surrounds three sides of the guide rail.

7. The device according to claim 5, wherein the driver by the driving slide is displaceable within the slotted guide track and when interacting with a detent of the slotted guide track raises the first tilting lever during the continuing displacement of the driving slide and, as a result, lifts a cover front edge and subsequently, during the continuing displacement of the driving slide, entrains the raised first tilting lever and the lifted cover.

8. The device according to claim 1, wherein the guide rail comprises a locking slotted guide track and the lever mechanism comprises a locking lever having a locking protrusion, wherein the locking lever is on one side coupled to the driving slide and on the other side coupled to the guide rail in such a way that the locking protrusion within the locking slotted guide track is able to be transferred between an unlocked and a locked state by the driving slide.

9. The device according to claim 8, wherein the locking lever is on one side coupled in a sliding manner to the driving slide and on the other side is pivotably coupled to a second tilting lever of the lever mechanism, and is mounted so as to be guidable within one or a plurality of slotted guide tracks of the guide rail in such a way that, by the driving slide, the locking lever is able to be driven and the second tilting lever is able to be raised and, as a result, a cover rear edge is able to be lifted and the locking lever by the locking protrusion within the locking slotted guide track secures the raised second tilting lever.

10. The device according to claim 9, wherein the second tilting lever by a slider is coupled in a sliding manner to the cover in such a way that, during the continuing displacement of the driving slide, the cover is displaceable in a sliding manner relative to the raised and secured second tilting lever.

11. A vehicle roof for a motor vehicle, having:
a roof bodywork which surrounds an opening in the vehicle roof; and
a device according to claim 1, which is coupled to the roof bodywork in such a way that the cover closes or by the lever mechanism exposes the opening in the vehicle roof when required.
